(19) United States
(12) Patent Application Publication
(10) Pub. No.: US 2010/0017383 A1
(43) Pub. Date: Jan. 21, 2010

(54) SYSTEM AND METHOD FOR PUBLICATION WEBSITE SUBSCRIPTION RECOMMENDATION BASED ON USER-CONTROLLED BROWSER HISTORY ANALYSIS

(75) Inventor: Dale E. Gaucas, Penfield, NY (US)

Correspondence Address: Gibb Intellectual Property Law Firm, LLC, 2568-A Riva Road Suite 304, Annapolis, MD, 21401, US

(73) Assignee: XEROX CORPORATION, NORWALK, CT (US)

(21) Appl. No.: 12/173,582

(22) Filed: Jul. 15, 2008

(51) Int. Cl. G06F 7/06; G06F 17/30

(52) U.S. Cl. 707/5; 707/E17.014

(57) ABSTRACT

A method receives user restrictions and establishes a list of recognized publication websites. The publication websites comprise websites that provide, for example, research papers and research articles. The method periodically scans Internet browser history files located on different user's computers (as limited by the user restrictions) to identify publication websites within the Internet browser history files. The method analyzes the website addresses and metadata associated with the publication websites to identify the publication service providers utilized, and to identify the journals, titles, authors, keywords, and abstracts of research papers and research articles accessed. Then, the methods herein can generate statistics regarding the publication service providers, and statistics regarding research topics based on the journals, titles, authors, keywords, and abstracts. Thus, the methods herein output recommendations regarding preferred publication service providers and preferred research topics based on the statistics.

### BACKGROUND AND SUMMARY

Embodiments herein generally relate to making recommendations regarding the usefulness of research publication websites, and more particularly to a method that utilizes browser history analysis to make such recommendations.

A fundamental part of research is reading published works in an area of focus, many of which are available online. Some research articles are available free of charge from university, consortium and research organization websites. During a web search, however, results returned are most frequently from subscription-based or fee-per-article-based online journals, proceedings, professional societies, publishers, and research dissemination services. Visiting such links enables the user to see information such as the title, authors, and abstract of the found article, but not the full article, often resulting in a frustrating experience.

Organizations such as corporate research centers may offer their researchers a service that enables the purchase of research articles from various sources in the hope of reducing corporate library journal subscriptions, both hardcopy and online. Such services, however, can be cumbersome to use, unreliable, and often result in significant delay in document delivery. In addition, document purchase decisions have to be based on the limited knowledge provided in the abstract of the article which may not indicate the technical depth of the article.

In order to address such issues, disclosed herein are methods and systems for obtaining browser history statistics on visits to fee-based research web sites resulting from a researcher's web searches. The data is periodically gathered and sent to an entity such as an organization's library for additional analysis. The data gathered is used in making purchase decisions such as whether to subscribe to direct corporate accounts for online publications, professional societies, publishers, etc., or for individual books or journals.

For example, one embodiment herein can be a client-based application that allows complete user control of the final list of publication sites being searched for in the user's history of links to visited sites, and of the scheduling of such searches; the initial list of publication sites can be provided by the organization and can be edited by the user. The date and link statistics are periodically emailed to the library or uploaded to an accessible document management system; the scheduling of such data transfer from the client is also under user control.

Subsequent analysis of the links' HTML pages can provide additional information such as journal name, article title, authors, key words and abstracts, where “journal” also refers to publications such as proceedings, etc. This data can then be used to make recommendations regarding purchases of organizational subscriptions to research sites, publications, or books, thereby allowing researchers easier direct access to materials. The data can also be used by the corporation to determine current research interests, and therefore help focus the selection of invited speakers and university research funding.

Thus, one method embodiment herein receives user restrictions and establishes a list of recognized publication websites. The publication websites comprise websites that provide, for example, research papers and research articles. The method periodically scans Internet browser history files located on different users' computers (different computing devices) as limited by the user restrictions, to identify publication websites within the Internet browser history files. Further, in some embodiments, the method can restrict the publication websites from being removed from the Internet browser history files until the scanning process is performed.

The method analyzes the website addresses and metadata associated with the publication websites to identify the publication service providers utilized, and to identify journal names, titles, authors, keywords, and abstracts of research papers and research articles accessed. This metadata comprises hypertext markup language (HTML) code relating to the publication websites within the Internet browser history files, and the website addresses comprise universal resource locator (URL) website addresses.

Then, the methods herein can generate statistics regarding the publication service providers, and statistics regarding research topics based on the journals, article titles, authors, keywords, and abstracts. In one example, the method can rank the publication service providers according to frequency of usage. Thus, the methods herein output recommendations regarding preferred publication service providers and preferred research topics based on the statistics. In addition to the recommendations, the method can also output at least some of the statistics.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating a flow of one method embodiment herein;

FIG. 2 is a schematic diagram of a screenshot of an internet browser web page;

FIG. 3 is a schematic diagram of a screenshot of an internet browser web page;

FIG. 4 is a schematic diagram of a screenshot of an internet browser history file;

FIG. 5 is a schematic diagram of a screenshot of an internet browser history file;

FIG. 6 is a schematic diagram of a screenshot of an internet browser web page;

FIG. 7 is a schematic diagram of a screenshot of an html tags;

FIG. 8 is a schematic diagram of a screenshot of index terms;

FIG. 9 is a schematic diagram of a screenshot of user interface for inputting browser scan restrictions; and

FIG. 10 is a schematic diagram of a system useful with embodiments herein.

### DETAILED DESCRIPTION

As mentioned above, it is difficult for organizations to know which publication websites are worthwhile. The embodiments herein address this issue with an automated system and method that produces recommendations regarding publication websites.

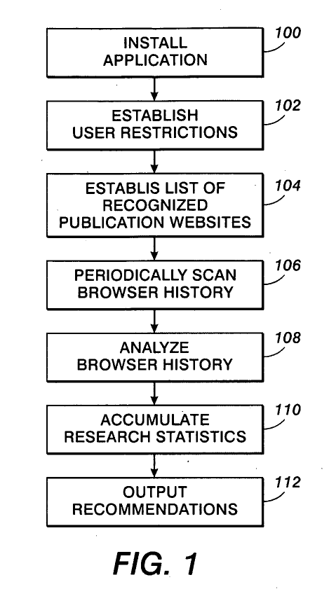

FIG. 1 generally illustrates one exemplary method in flowchart form to present a brief overview of some aspects of the embodiments herein. As shown in item 100, this flowchart begins with the installation of an application on a user's computer (e.g., a researcher's computer) that allows the scanning of the browser history. This essentially allows a different computer to access the Internet browser history file on the researcher's computer. The details regarding remote operation of one computer by another are well-known by those ordinarily skilled in the art as evidenced by U.S. Pat. No. 6,347,375 (the complete disclosure of which is incorporated herein by reference) and the details of such systems are not discussed herein.

In order to protect the privacy of the researcher, during the installation of the application in item 100, the user (researcher) is provided many options whereby the user can restrict what aspects of browser history can be scanned. Thus, in item 102, the flowchart includes a step whereby the user establishes various restrictions on the ability of the application to access the user's browser history. The user selections can be entered in a user interface that can include check boxes, buttons, etc. by which the user can indicate their preferences, as shown in FIG. 9, discussed below.

For example, such restrictions in item 100 can include restrictions on the topical nature of websites that can be scanned (e.g., only allowing the browsing history of research publications websites to be scanned); time and date restrictions of when the scan can be performed; time and date restrictions regarding when the browsing activity occurred (e.g., only scan the history of websites that were viewed during normal working hours, during weekdays), etc. For purposes herein, “publication websites” are considered those websites that have a primary purpose of providing full copies of research papers and research articles, either freely or for a fee. Further, in some embodiments, when installing the application 100, the user can establish restrictions 102 that prevent research publication websites from being deleted from the user's Internet browser history files (during manual or automated deletion of browser history files) until the scanning process is performed.

In addition, as shown in item 104, some embodiments herein can establish a list of recognized publication websites. This list can be created manually or automatically by an administrator or various users, and can be updated from time to time by the administrator and/or by the users. For example, the list can include the top 50, top 100, top 500, etc., worldwide research publication websites; or any other criteria could be utilized to make up the list of recognized publication websites.

As shown in item 106, using the application the method periodically scans the Internet browser history files located on the computing devices (as limited by the user restrictions). The details regarding scanning and managing browser history files are well-known by those ordinarily skilled in the art as evidenced by U.S. Pat. No. 7,359,935 (the complete disclosure of which is incorporated herein by reference) and the details of such systems are not discussed herein. This scanning can be performed by each individual computer itself (with the results of each scan being sent to a centralized location (centralized database or server)); or the scanning can be performed remotely by the centralized database or server. In any case, the scanning process identifies publication websites within the Internet browser history files. Each of these entries in the Internet browser history files includes website addresses and metadata from the website.

Then, in item 108, the method analyzes the website addresses and metadata associated with the publication websites. This metadata comprises hypertext markup language (HTML) code relating to the publication websites within the Internet browser history files, and the website addresses comprise universal resource locator (URL) website addresses. The details regarding analyzing HTML and other codes are well-known by those ordinarily skilled in the art as evidenced by U.S. Pat. No. 7,100,112 (the complete disclosure of which is incorporated herein by reference) and the details of such systems are not discussed herein. As shown below, this metadata provides sufficient information to identify the publication service providers utilized, and to identify the journal publications, titles, authors, keywords, and abstracts of research papers and research articles accessed. Again, this analysis 108 can be performed locally at each different computer (with the results being sent to a centralized database or server) or the analysis can be performed by the centralized database or server.

Then, as shown in item 110, based on the analysis performed in item 108, the methods herein generate statistics regarding the publication service providers, and statistics regarding research topics based on the journals, article titles, authors, keywords, and abstracts. In one example, the method can rank the publication service providers or journals according to frequency of usage (frequency of access) and can generate a list of most popular research topics. Thus, in item 112, the methods herein output recommendations regarding preferred (most frequently accessed) publication service providers, preferred (most frequently accessed) journal publications and preferred (most popular) research topics based on the statistics. The recommendations can include any information generated by the accumulation of the research statistics 110, and can include recommending the most popular (most useful) publication websites, journal publications, books, research papers, authors, topics, etc. In addition to the recommendations, the method can also output at least some of the statistics to aid the user in understanding the recommendations.

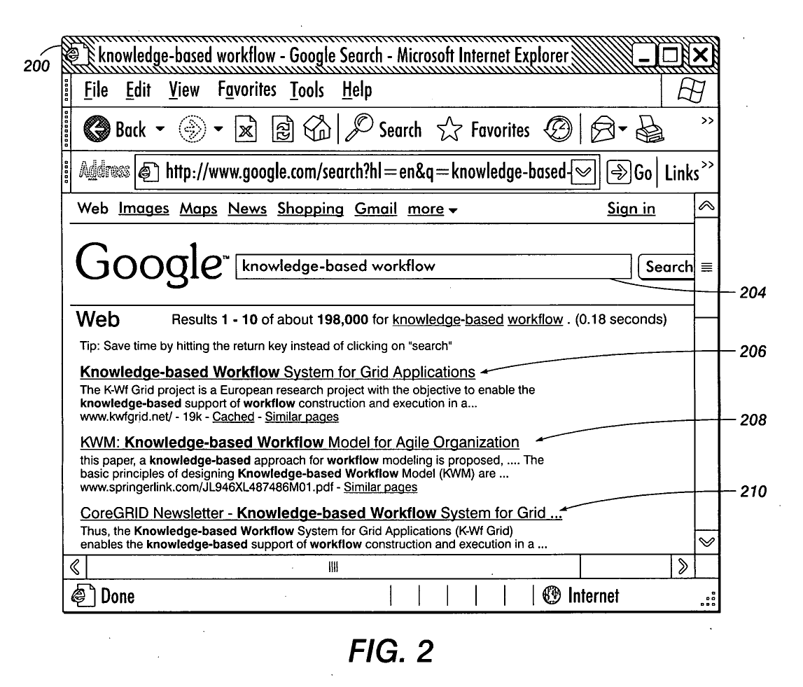

FIGS. 2-8 that are discussed below provide one example of how the embodiments herein could operate. Those ordinarily skilled in the art would understand that the embodiments herein are not limited to these specific examples, but instead that these examples are merely presented to demonstrate one way in which the embodiments herein could operate. Therefore, the embodiments herein are not limited to the following examples. Specifically, the following example utilizes a Windows® Internet Explorer® browser available from Microsoft Corporation (Redmond, Wash., U.S.A.).

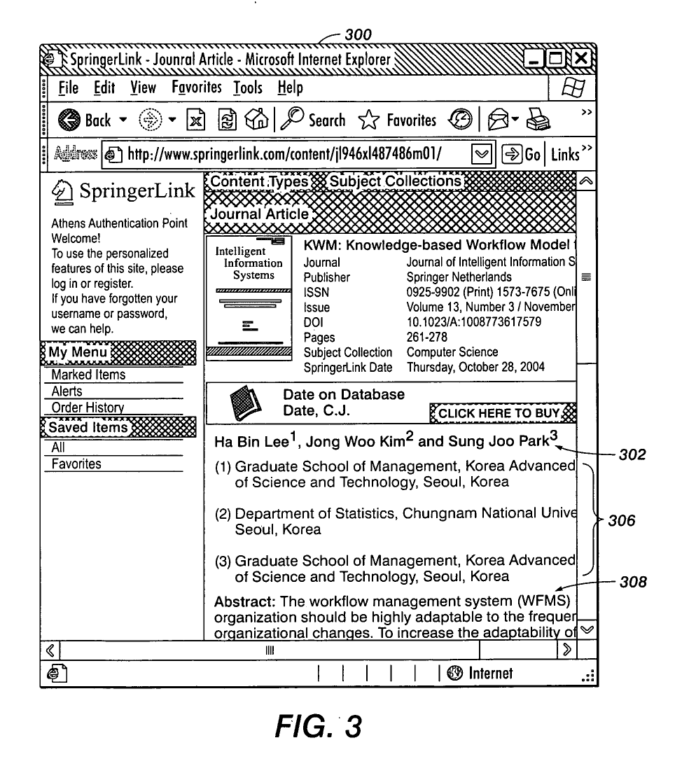

When searching, using keywords 204 for research papers in a technical area using the Google® search engine (www.google.com) 200 as shown in FIG. 2, following a link 206-210 often leads to a publication web site and a paper abstract whose full article requires a subscription or single payment as shown in FIG. 3. The publication service can be, for example, an online journal, proceedings, professional society, publisher, or research dissemination service. More specifically, FIG. 3 illustrates a browser page 300 on a result link to a webpage of SpringerLink® (www.springerlink.com) that lists authors' names 302, the authors' positions/titles 306, and an abstract 308.

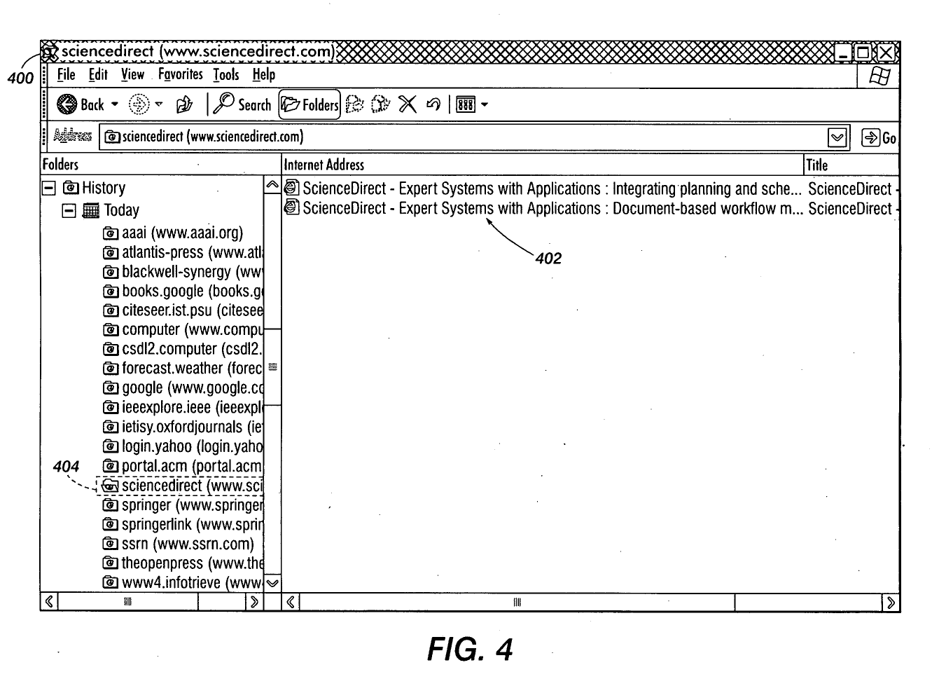

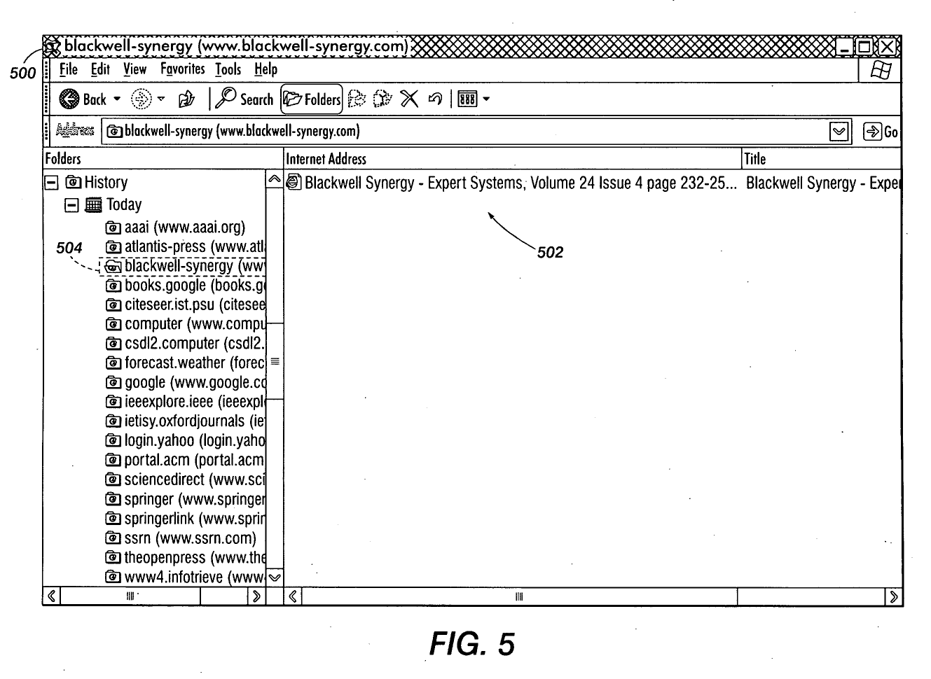

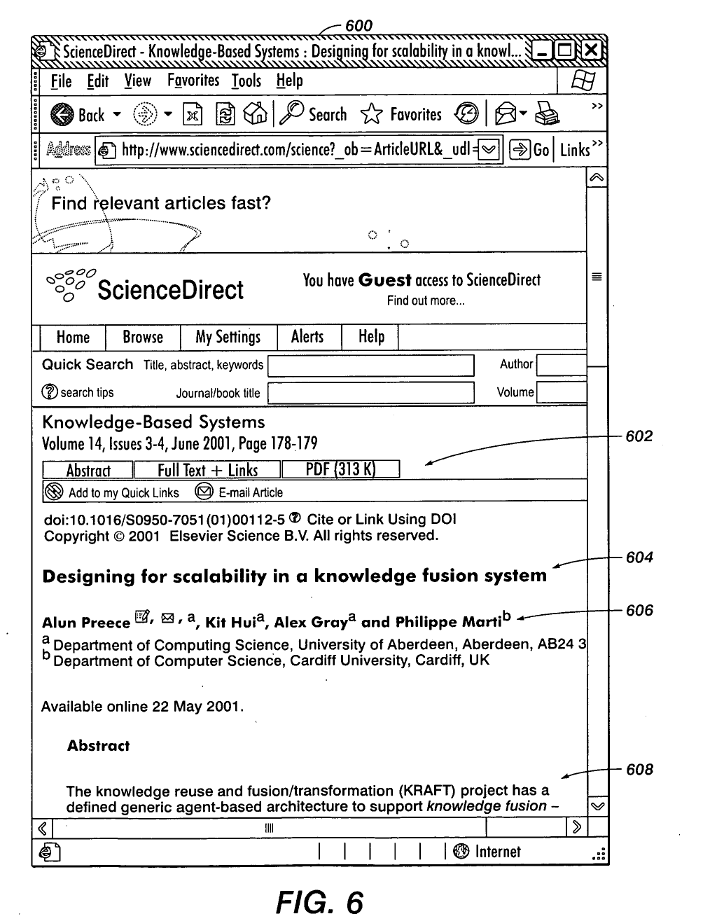

Browsers such as Windows® Internet Explorer® maintain a history file that keeps track of visits to websites (including such publication sites) by aggregating visits to site universal resource locators (URLs) as shown in FIGS. 4 and 5. More specifically, FIG. 4 illustrates a screenshot 400 of a history of abstracts read on the ScienceDirect® (www.ScienceDirect.com) website. FIG. 6 illustrates a browser page 600 of an abstract of a paper on the ScienceDirect® website that includes the title of a publication 602, the title of a specific paper or section 604, the authors 606, and the abstract 608. FIG. 5 illustrates a screenshot 500 of a history of journals accessed on the Blackwell Synergy® (www.Blackwell-Synergy.com) website.

As discussed above, the embodiments herein comprise a server or a client-based application that periodically scans a researcher's browser history for specific publication sites and gathers data about the publication site name, the frequency of visits to that site link, and the specific article or abstract being accessed. This data is subsequently transmitted to an organization (such as a library, via email) or a document repository for further analysis.

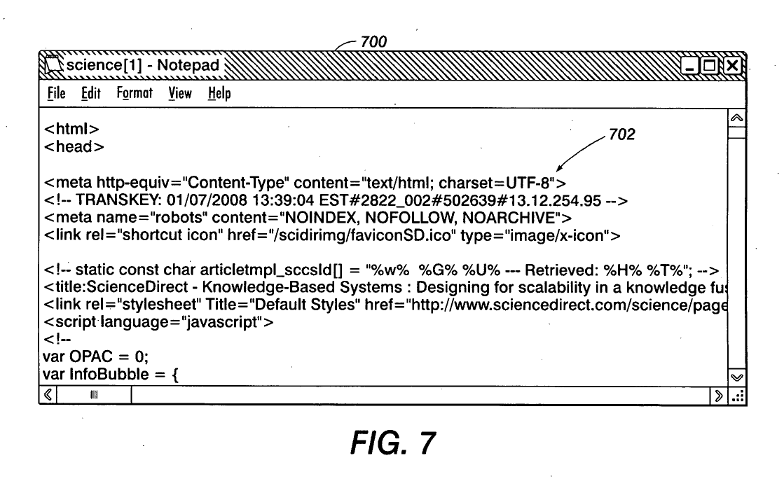

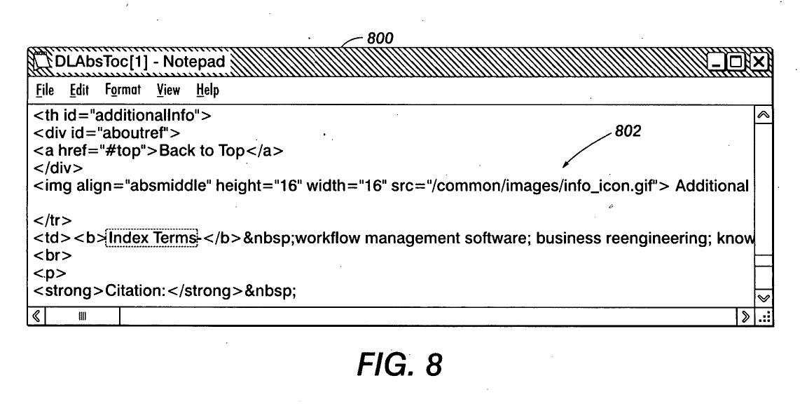

The analysis of the link URL as well the hypertext markup language (HTML) of the specific pages accessed can provide information about the publication service as well as the article's metadata such as journal name, article title, authors, keywords, and abstract. FIG. 4 shows how a browser analyzes a page's HTML from folder 404 to extract the article title 402 and display it in the history. FIG. 5 shows the name of the journals 502 accessed on Blackwell Synergy® publisher site from folder 504. FIG. 7 shows a screenshot 700 of some of the HTML source and title tags 702 of the paper abstract displayed in FIG. 6. FIG. 8 similarly shows a screenshot 800 of some HTML source and an index term element values 802. The keywords are recognized from such metadata as shown in FIGS. 7 and 8 to permit the metadata to be analyzed and recommendations to be made, as discussed above with respect to items 110-112.

As mentioned above, the embodiments herein allow full user control of the initial list of publication sites and frequency of scans. Such user control of what sites are being monitored for statistics and where and when the data is sent allows users to trust that the system is not recording search history data for any sites other than those on the list of publication sites. Some embodiments can incorporate daily data gathering to minimize data loss, because the user has full control to clear their browser history whenever they choose. A variation embodiment leaves links to sites on the publication list intact when a user deletes their browser history file, so that browser history analysis can be done on a less frequent interval.

The analyzed browser history data can be used by libraries in determining a strategy for buying corporate subscriptions to publications, services, professional societies, and books. The data can also be used by management to determine what research topics are currently being pursued, and for example, can provide input in the selection of invited speakers, the funding of universities, the hiring of interns, etc.

As mentioned above in item 102, the user can provide many restrictions on what can be scanned from the browser history file. For example, as shown in FIG. 9, the user selections can be entered in a user interface 900 that can include check boxes, buttons, etc., by which the user can indicate their preferences of which types of website history can be scanned 902 and the times at which the scanning can be done (and restrictions on which history items can be scanned, based on when the websites were visited by the user) 904.

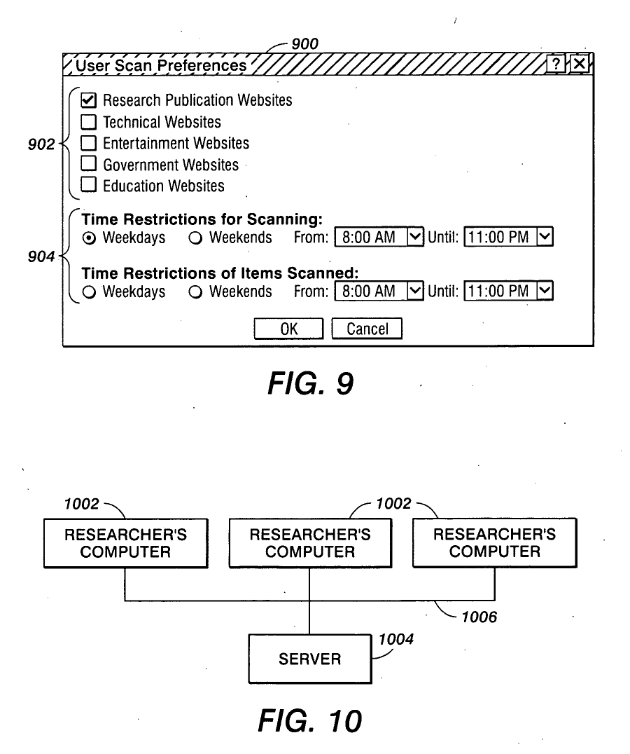

FIG. 10 illustrates one exemplary system in which the embodiments herein could operate. FIG. 10 illustrates different researchers' computers 1002, a file server 1004 and a network 1006 (local area network, wide area network, e-mail system, etc.). Many such computerized devices are commonly available. Computerized devices that include chip-based central processing units (CPU's), input/output devices (including graphic user interfaces (GUI), memories, comparators, processors, etc. are well-known and readily available devices produced by manufacturers such as International Business Machines Corporation, Armonk N.Y., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein.

The application located on each user's computer 1002 periodically scans Internet browser history files located on the different users' computers 1002 as limited by the user restrictions, to identify publication websites within the Internet browser history files. The method analyzes the website addresses and metadata associated with the publication websites (at the file server 1004, or at one or more of the users' computers 1002) to identify the publication service providers utilized, and to identify journal names, titles, authors, keywords, and abstracts of research papers and research articles accessed, and perform the processing discussed above.

Thus, as shown above, the embodiments herein provide methods and systems for obtaining browser history statistics on visits to fee-based research web sites resulting from a researcher's web searches. The data is periodically gathered and sent to an entity such as an organization's library for additional analysis. The data gathered is used in making purchase decisions such as whether to subscribe to direct corporate accounts for online publications, professional societies, publishers, etc., or for individual books or journals.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein should not be implied or imported from any above example as limitations to any particular order, number, position, size, shape, angle, color, or material.

What is claimed is:

1. A method comprising:
periodically scanning a plurality of Internet browser history files located on different computing devices to identify publication websites within said Internet browser history files, said publication websites comprising websites that provide research papers and research articles;
analyzing website addresses and metadata associated with said publication websites to identify publication service providers and journals utilized, and to identify titles, authors, keywords, and abstracts of research papers and research articles accessed;
generating statistics regarding said publication service providers and regarding research topics based on said journals, titles, authors, keywords, and abstracts; and
outputting recommendations regarding preferred publication service providers and preferred research topics based on said statistics.

2. The method according to claim 1, said generating of said statistics comprising ranking said publication service providers according to frequency of usage.

3. The method according to claim 1, said outputting of recommendations further comprising outputting at least some of said statistics.

4. The method according to claim 1, further comprising restricting said publication websites from being removed from said Internet browser history files until said scanning is performed

5. The method according to claim 1, said metadata comprising hypertext markup language (HTML) code relating to said publication websites within said Internet browser history files, and said website addresses comprising universal resource locator (URL) addresses.

6. A method comprising:
receiving user restrictions;
periodically scanning a plurality of Internet browser history files located on different computing devices as limited by said user restrictions to identify publication websites within said Internet browser history files, said publication websites comprising websites that provide research papers and research articles;
analyzing website addresses and metadata associated with said publication websites to identify publication service providers and journals utilized, and to identify titles, authors, keywords, and abstracts of research papers and research articles accessed;
generating statistics regarding said publication service providers and regarding research topics based on said journals, titles, authors, keywords, and abstracts; and
outputting recommendations regarding preferred publication service providers and preferred research topics based on said statistics.

7. The method according to claim 6, said generating of said statistics comprising ranking said publication service providers according to frequency of usage.

8. The method according to claim 6, said outputting of recommendations further comprising outputting at least some of said statistics.

9. The method according to claim 6, further comprising restricting said publication websites from being removed from said Internet browser history files until said scanning is performed.

10. The method according to claim 6, said metadata comprising hypertext markup language (HTML) code relating to said publication websites within said Internet browser history files, and said website addresses comprising universal resource locator (URL) addresses.

11. A method comprising:
receiving user restrictions;
establishing a list of recognized publication websites, said publication websites comprising websites that provide research papers and research articles;
periodically scanning a plurality of Internet browser history files located on different computing devices as limited by said user restrictions to identify publication websites within said Internet browser history files;
analyzing website addresses and metadata associated with said publication websites to identify publication service providers and journals utilized, and to identify titles, authors, keywords, and abstracts of research papers and research articles accessed;
generating statistics regarding said publication service providers, and regarding research topics based on said journals, titles, authors, keywords, and abstracts; and
outputting recommendations regarding preferred publication service providers and preferred research topics based on said statistics.

12. The method according to claim 11, said generating of said statistics comprising ranking said publication service providers according to frequency of usage.

13. The method according to claim 11, said outputting of recommendations further comprising outputting at least some of said statistics.

14. The method according to claim 11, further comprising restricting said publication websites from being removed from said Internet browser history files until said scanning is performed.

15. The method according to claim 11, said metadata comprising hypertext markup language (HTML) code relating to said publication websites within said Internet browser history files, and said website addresses comprising universal resource locator (URL) addresses.

16. A computer program storage comprising:
a computer-readable computer storage medium storing instructions that, when executed by a computer, cause the computer to perform a method comprising:
periodically scanning a plurality of Internet browser history files located on different computing devices to identify publication websites within said Internet browser history files, said publication websites comprising websites that provide research papers and research articles;
analyzing website addresses and metadata associated with said publication websites to identify publication service providers and journals utilized, and to identify titles, authors, keywords, and abstracts of research papers and research articles accessed;
generating statistics regarding said publication service providers and regarding research topics based on said journals, titles, authors, keywords, and abstracts; and
outputting recommendations regarding preferred publication service providers and preferred research topics based on said statistics.

17. The computer program storage according to claim 16, said generating of said statistics comprising ranking said publication service providers according to frequency of usage.

18. The computer program storage according to claim 16, said outputting of recommendations further comprising outputting at least some of said statistics.

19. The computer program storage according to claim 16, further comprising restricting said publication websites from being removed from said Internet browser history files until said scanning is performed

20. The computer program storage according to claim 16, said metadata comprising hypertext markup language (HTML) code relating to said publication websites within said Internet browser history files, and said website addresses comprising universal resource locator (URL) addresses.
